(19) United States
(12) Patent Application Publication
(10) Pub. No.: US 2022/0112581 A1
(43) Pub. Date: Apr. 14, 2022

(54) PROCESS FOR MANUFACTURING AN ALUMINUM ALLOY PART

(71) Applicant: C-TEC CONSTELLIUM TECHNOLOGY CENTER, Voreppe (FR)

(72) Inventor: Bechir CHEHAB, Voiron (FR)

(21) Appl. No.: 17/277,724

(22) PCT Filed: Sep. 19, 2019
(86) PCT No.: PCT/FR2019/052204

§ 371 Date: Mar. 18, 2021

(30) Foreign Application Priority Data
Sep. 21, 2018 (FR) 1871070

(51) Int. Cl. C22C 21/16; B33Y 10/00; B33Y 40/20; B33Y 70/00; B22F 10/28; B22F 10/64; C22C 21/08

(52) U.S. Cl. CPC C22C 21/16; B33Y 10/00; B33Y 40/20; B33Y 70/00; B23K 26/342; B22F 10/64; C22C 21/08; B22F 2301/052; B22F 10/28

(57) ABSTRACT

Process for manufacturing a part (20), comprising a formation of successive metal layers (201 . . . 20n) which are superimposed on each other, each layer describing a pattern which is defined on the basis of a numerical model (M), each layer being formed by the deposit of a filler metal (15, 25), the filler metal being subjected to a supply of energy so as to become molten and to constitute, upon solidifying, said layer, the process being characterised in that the filler metal (15, 25) is an aluminium alloy comprising the following alloy elements (% by weight): Cu: 5%-8%; Mg: 4%-8%; optionally Si: 0%-8%; optionally Zn: 0%-10%; and other elements: <2% individually, the other elements comprising: Sc and/or Fe and/or Mn and/or Ti and/or Zr and/or V and/or Cr and/or Ni; impurities: <0.05% individually, and in total <0.15%; the remainder being aluminium.

### TECHNICAL FIELD

The technical field of the invention is a process for manufacturing an aluminum alloy part, using an additive manufacturing technique.

### PRIOR ART

Since the 1980s, additive manufacturing techniques have been developed. They consist of forming a part by adding material, which is the opposite of machining techniques, aimed at removing material. Previously confined to prototyping, additive manufacturing is now operational for manufacturing mass-produced industrial products, including metallic parts.

The term “additive manufacturing” is defined as per the French standard XP E67-001: “set of processes for manufacturing, layer upon layer, by adding material, a physical object from a digital object”. The standard ASTM F2792 (January 2012) also defines additive manufacturing. Various additive manufacturing methods are also defined in the standard ISO/ASTM 17296-1. The use of additive manufacturing to produce an aluminum part, with a low porosity, was described in the document WO2015006447. The application of successive layers is generally carried out by applying a so-called filler material, then melting or sintering the filler material using an energy source such as a laser beam, electron beam, plasma torch or electric arc. Regardless of the additive manufacturing method applied, the thickness of each layer added varies from some tens of microns to a few millimeters.

Other publications describe the use of aluminum alloys as a filler metal, in the form of a powder or a wire. La publication Gu J. “Wire-Arc Additive Manufacturing of Aluminium” Proc. 25th Int. Solid Freeform Fabrication Symp., August 2014, University of Texas, 451-458, describes an example of an additive manufacturing method described using the term WAAM, an acronym of “Wire+Arc Additive Manufacturing” on aluminum alloys for forming low-porosity parts intended for the field of aeronautics. The WAAM process is based on arc welding. It consists of stacking various layers successively on one another, each layer corresponding to a weld bead formed from a wire. This process makes it possible to obtain a relatively large cumulative mass of deposited material, of up to 3 kg/h. When this process is implemented using an aluminum alloy, the latter is generally a 2319 type alloy. The Fixter publication “Preliminary Investigation into the Suitability of 2xxx Alloys for Wire-Arc Additive Manufacturing” studies the mechanical properties of parts manufactured using the WAAM method, using several aluminum alloys.

More particularly, the copper content being maintained between 4 and 6% by mass, the authors varied the magnesium content and determined the hot cracking susceptibility of 2xxx alloys when implementing a WAAM type process. The authors conclude that an optimal magnesium content is 1.5%, and that 2024 aluminum alloy is particularly suitable.

Further additive manufacturing methods can be used. Let us mention for example, and non-restrictively, melting or sintering a filler material taking the form of a powder. This may consist of laser melting or sintering. Patent application US20170016096 describes a process for manufacturing a part by localized melting obtained by exposing a powder to an electron beam or laser beam type energy, the process also being known as the acronyms SLM, meaning “Selective Laser Melting”, or “EBM”, meaning “Electron Beam Melting”. The powder is formed from an aluminum alloy wherein the copper content is between 5% and 6% by mass, the magnesium content being between 2.5% and 3.5% by mass.

The Qi Zewu publication “Microstructure and mechanical properties of double-wire+arc additively manufactured Al—Cu—Mg alloys”, Journal of Materials Processing Technology, 255 (2018), 345-353, describes the WAAM process as being particularly adapted to the manufacture of aluminum alloy parts, intended for the aeronautical industry. This publication analyzes the properties of parts obtained using the WAAM process. For this, two different filler wires are used, for obtaining different Cu and Mg contents. Parts are thus obtained wherein the mass fraction of Cu and Mg is respectively: 3.6%-2.2%, 4%-1.8%, 4.4%-1.5%. The publication shows that the hardness increases as the Cu/Mg ratio increases.

The mechanical properties of aluminum parts obtained by additive manufacturing are dependent on the alloy forming the filler metal, and more specifically on the composition thereof as well as on the thermal treatments applied following the implementation of additive manufacturing.

The inventors determined an alloy composition which, used in an additive manufacturing process, makes it possible to obtain parts with remarkable mechanical performances, without it being necessary to implement thermal treatments such as solution heat treatments and quenching.

### DESCRIPTION OF THE INVENTION

The invention firstly relates to a process for manufacturing a part including a formation of successive metal layers, which are superimposed on each other, each layer being formed by depositing a filler metal, the filler metal being subjected to a supply of energy so as to become molten and to constitute, upon solidifying, said layer, the process being characterized in that the filler metal is an aluminum alloy including the following alloy elements (% by weight);
Cu: 5%-8%;
Mg: 4%-8%;
optionally Si: 0%-8%;
optionally Zn: 0%-10%;
   as well as:
other elements: <3% individually and preferably <2% individually, the other elements including: Sc and/or Fe and/or Mn and/or Ti and/or Zr and/or V and/or Cr and/or Ni;
impurities: <0.05% individually, and in total <0.15%;

the remainder being aluminum.

The aluminum alloy can be such that Mg: 4.5%-8%, and preferably such that Mg: 5%-8%.

Each layer can particularly describe a pattern defined on the basis of a digital model.

The term other elements denotes addition elements, different from the alloy elements Cu, Mg, and from the optional alloy elements Si and Zn present in the alloy.

Preferably, the mass fraction of the other elements, taken as a whole, is less than 10%, and preferably less than 5%.

The aluminum alloy can particularly include, among the other elements:
Fe: <2%, preferably 0.05%-2%, more preferably 0.05%-1%, and even more preferably 0.05%-0.5%;
and/or Mn: <2%, preferably 0.05%-2%, more preferably 0.05%-1%, and even more preferably 0.05%-0.4%;
and/or Ti: <2%, preferably 0.05%-2%, more preferably 0.05%-1%, and even more preferably 0.05%-0.4%;
and/or Zr: <2%, preferably 0.05%-2%, more preferably 0.05%-1%, and even more preferably 0.05%-0.5%;
and/or V: <2%, preferably 0.05%-2%, more preferably 0.05%-1%, and even more preferably 0.08%-0.5%;
and/or Sc: <2%, preferably 0.05%-1%, and more preferably 0.05%-0.5%;
and/or Cr: <2%, preferably 0.05%-2%, more preferably 0.05%-1%, and even more preferably 0.05%-0.5%;
and/or Ni: <2%, preferably 0.05%-2%, more preferably 0.05%-1%, and even more preferably 0.05%-0.5%.

According to an embodiment, the aluminum alloy includes Si: 0.05%-1%, preferably 0.2%-1%.

According to a further embodiment, the aluminum alloy includes Si >1%. For example, Si: 1%-8%.

The aluminum alloy can include Sc: 0.05%-1% and/or Zr: 0.05%-2%, preferably Sc: 0.05%-1% and Zr: 0.05%-2%.

According to an alternative embodiment, the aluminum alloy may not include Zn or else in quantities less than 0.05%, as an impurity.

According to an alternative embodiment, the aluminum alloy can be such that:
Cu: 5%-7%;
Mg: 4%-6%, and preferably 4.5%-8%;
Si: <1%;
Fe: <1%;
Mn: <0.4% and preferably 0.05%-0.4%;
Ti: <0.5% and preferably 0.05%-0.4%;
Zr: <0.5% and preferably 0.05%-0.5%;
V: <0.5% and preferably 0.08%-0.5%.

According to a further alternative embodiment, the aluminum alloy can be such that:
Cu: 5%-8%;
Mg: 4%-8%, and preferably 4.5%-8%;
Si: 1%-8%;
Sc: <0.5%;
Fe: <1%;
Mn: <0.4% and preferably 0.05%-0.4%;
Ti: <0.5% and preferably 0.05%-0.4%;
Zr: <0.5% and preferably 0.05%-0.5%;
V: <0.5% and preferably 0.08%-0.5%.

Preferably, the alloy according to the present invention comprises a mass fraction of at least 85%, more preferably of at least 90% of aluminum.

The process can include, following the formation of the layers, an application of at least one thermal treatment. The thermal treatment can be or include an aging or an annealing. It can also include a solution heat treatment and a quenching. It can also include a hot isostatic compression.

According to an advantageous embodiment, the process does not include a quenching type thermal treatment following the formation of the layers. Thus, preferably, the process does not include steps of solution heat treatment followed by a quenching.

According to a further embodiment, the filler metal is obtained from a filler wire, the exposure of which to an electric arc results in a localized melting followed by a solidification, so as to form a solid layer. According to a further embodiment, the filler metal takes the form of a powder, the exposure of which to a light beam or charged particles results in a localized melting followed by a solidification, so as to form a solid layer. The melting of the powder can be partial or complete. Preferably, from 50 to 100% of the exposed powder becomes molten, more preferably from 80 to 100%.

The invention secondly relates to a metal part, obtained after applying a process according to the first subject matter of the invention.

The invention thirdly relates to a filler metal, particularly a filler wire or a powder, intended to be used as a filler material of an additive manufacturing process, characterized in that it is formed from an aluminum alloy, including the following alloy elements (% by weight):
Cu: 5%-8%;
Mg: 4%-8%;
at least one from: Sc: 0.05%-1% and/or Zr: 0.05%-2%, preferably Sc: 0.05%-1% and Zr: 0.05%-2%;
optionally Si: 0%-8%;
optionally Zn: 0%-10%;
   as well as:
other elements: <2% individually, the other elements including: Fe and/or Mn and/or Ti and/or V and/or Cr and/or Ni;
impurities: <0.05% individually, and in total <0.15%;

the remainder being aluminum.

The aluminum alloy forming the filler material can have the features described in relation to the first subject matter of the invention.

When the filler material is presented in the form of a wire, the diameter of the wire can particularly be between 0.5 mm and 3 mm, and preferably between 0.5 mm and 2 mm, and more preferably between 1 mm and 2 mm.

The filler material can be presented in the form of a powder. The powder can be such that at least 80% of the particles making up the powder have a mean size in the following range: 5 μm to 100 μm, preferably from 5 to 25 μm, or from 20 to 60 μm.

Further advantages and features will emerge more clearly from the following description of specific embodiments of the invention, given by way of non-limiting examples, and represented in the figures listed below.

### FIGURES

FIG. 1 is a diagram illustrating a WAAM type additive manufacturing process.

FIG. 2A schematically represents the geometry of test parts obtained by molding according to a first view.

FIG. 2B schematically represents the geometry of test parts obtained by molding according to a second view.

FIG. 3 shows the results of hardness measurements made along test parts.

FIG. 4 is a diagram illustrating an SLM type additive manufacturing process.

### DESCRIPTION OF SPECIFIC EMBODIMENTS

In the description, unless specified otherwise:
aluminum alloys are designated according to the nomenclature of the Aluminum Association;
the chemical element contents are designated as a % and represent mass fractions. The notation x %-y % means greater than or equal to x % and less than or equal to y %.

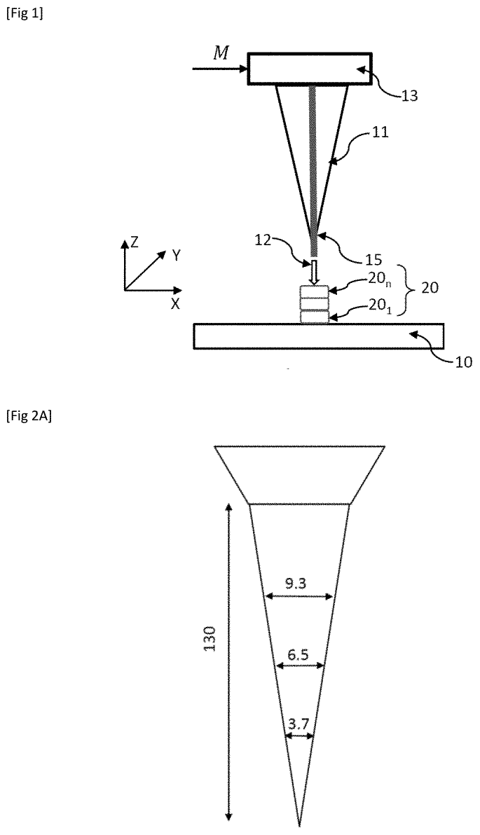

FIG. 1 represents a WAAM type additive manufacturing device, mentioned in relation to the prior art. An energy source 11, in this case a torch, forms an electric arc 12. In this device, the torch 11 is held by a welding robot 13. The part 20 to be manufactured is disposed on a support 10. In this example, the part manufactured is a wall extending along a transverse axis Z perpendicularly to a longitudinal plane XY defined by the support 10. Under the effect of the electric arc 12, a filler wire 15 becomes molten to form a weld bead. The welding robot is controlled by a digital model M. It is moved so as to form different layers 20₁ . . . 20ₙ, stacked on one another, forming the wall 20, each layer corresponding to a weld bead. Each layer 20₁ . . . 20ₙ extends in the longitudinal plane XY, according to a pattern defined by the digital model M.

The diameter of the filler wire is preferably less than 3 mm. It can be between 0.5 mm and 3 mm and is preferably between 0.5 mm and 2 mm, or between 1 mm and 2 mm. It is for example 1.2 mm.

The inventors implemented such a process to produce large-sized parts, intended to form structural elements in aircraft. They used a process as described in patent application FR1753315. In this patent application, it is shown that using a 2139 type alloy, it is possible to obtain a part manufactured by additive manufacturing, in which the Vickers hardness is up to 100 Hv. Applying thermal treatments such as solution heat treatment, quenching and aging (T6 state), the Vickers hardness is significantly increased, typically by 50% to 60%. The hardness can then attain values close to 160 Hv. However, the inventors observed that applying thermal treatments such as quenching could induce distortion of the part, due to the sudden temperature variation. The distortion of the part is generally all the more significant as the dimensions thereof are large. Yet, the advantage of an additive manufacturing process is specifically that of obtaining a part wherein the shape, after manufacturing is definitive, or virtually definitive. The occurrence of a significant deformation resulting from a thermal treatment is therefore to be avoided. By virtually definitive, it is understood that finishing machining can be performed on the part after the manufacturing thereof: the part manufactured by additive manufacturing extends according to the definitive shape thereof, apart from the finishing machining.

Having observed the above, the inventors sought an alloy composition, forming the filler material, making it possible to obtain acceptable mechanical properties, without requiring the application of thermal treatments, subsequent to the formation of the layers, liable to induce distortion. This particularly applies to thermal treatments involving a sudden temperature variation. Thus, the invention makes it possible to obtain, by additive manufacturing, a part wherein the mechanical properties are satisfactory, in particular in terms of hardness. According to the type of additive manufacturing process selected, the filler material can be presented in the form of a wire or a powder.

The inventors observed that, by combining a copper content of 5% to 8%, and a magnesium content greater than or equal to 4%, and less than or equal to 8%, it is possible to obtain a part manufactured by additive manufacturing, and for example by WAAM, wherein the mechanical properties are sufficiently satisfactory so as not to impose the application of thermal treatments involving large temperature variations, and particularly a quenching. The compositions described in the following examples make it possible to obtain a hardness of the order of 125 Hv (1^{st} example), or greater than 160 Hv (2^{nd} example). Furthermore, the combination of the copper and magnesium contents cited above makes it possible to obtain a low cracking susceptibility. Aluminum alloys having such contents are particularly compatible with the implementation of an additive manufacturing process.

Besides Cu and Mg, the alloy can include further alloy elements. The inventors observed that an Si content, less than or equal to 8%, can make it possible to obtain a high hardness, and enhance the cracking susceptibility. A Zn content, less than or equal to 10%, can also be envisaged.

According to an alternative embodiment, Zn can be absent from the alloy or present in a quantity less than 0.05%, as an impurity.

The alloy can also include Sc, according to a mass fraction less than or equal to 1%.

The alloy can also include at least one from: Sc: 0.05%-1% and/or Zr: 0.05%-2%, preferably Sc:

0.05%-1% and Zr: 0.05%-2%.

The alloy can also include further elements, as described following the description of the examples. In particular, the alloy can include Zr, according to a mass fraction from 0.05% to 2%, preferably from 0.05 to 0.5%, in particular from 0.05% to 0.25%. Adding Zr in contents as described in the present description can make it possible to refine the granular structure after melting. Zr can also have a positive impact on the mechanical properties and the ductility.

### EXAMPLES

### Example 1

A first series of tests was conducted using a first alloy A1, the composition of which is specified in Table 1 as mass fraction percentages. The mechanical properties obtained with a 2319 type alloy were compared, the latter being considered as a reference alloy for the additive manufacturing of aluminum parts. The mass fractions of the elements are identical, with the exception of Mg, the mass fraction whereof is respectively 5% (alloy A1) and 0% (alloy Ref 1, which corresponds to a 2319 alloy).

TABLE 1

| | Si | Fe | Cu | Mn | Mg | Ti | V | Zr |
|---|---|---|---|---|---|---|---|---|
| A1 | 0.1% | 0.2% | 5.7% | 0.3% | 5% | 0.1% | 0.1% | 0.1% |
| Ref 1 | 0.1% | 0.2% | 5.7% | 0.3% | 0% | 0.1% | 0.1% | 0.1% |

Each alloy was cast in a wedge mold as represented in FIGS. 2A and 2B. FIGS. 2A and 2B are front and side views of the test parts formed. The numeric values entered in FIGS. 2A and 2B are the dimensions, expressed in mm. This gives a molded part wherein a portion of interest corresponds to the cooling rate sustained during the implementation of a WAAM type process. The portion of interest is considered to correspond to the portion of the part in which the thickness is situated around 3.7 mm.

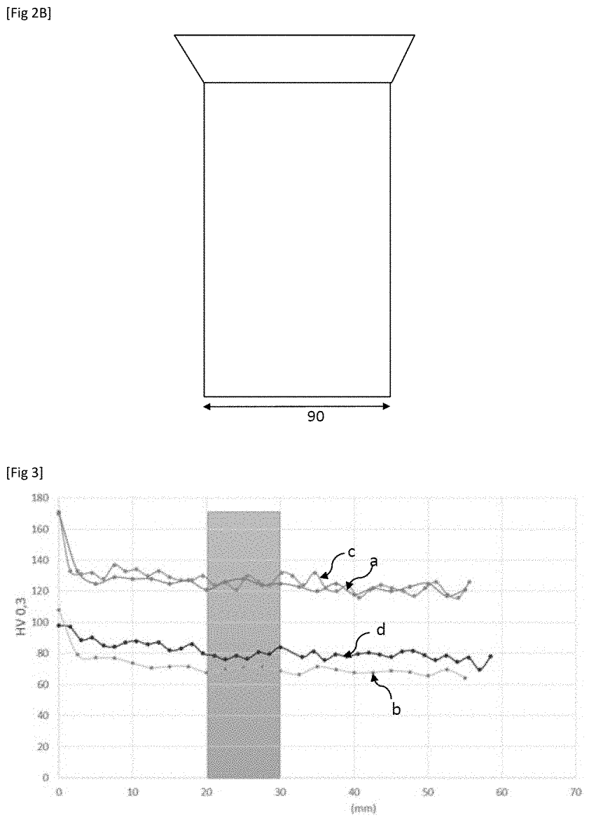

FIG. 3 represents hardness profile tests established along the test parts, the X-axis corresponding to the distance with respect to the tip of the part. The Y-axis represents the hardness HV 0.3. Curves a, b, c and d are profiles corresponding respectively to:
the part made of alloy A1, without aging;
the reference part made of alloy Ref 1 (2319), without aging;
the part made of alloy A1, the manufacture of the part being followed by an aging (15 h—175° C.);
the reference part made of alloy Ref 1 (2319), the manufacture of the part being followed by an aging (15 h—175° C.).

The grayed zone of FIG. 3 corresponds to the portion of interest representing the solidification conditions of a layer of metal formed using the WAAM method.

A mean of the different hardness values measured in the portion of interest was established.

The results are as follows:
part made of alloy A1, without aging: 125;
reference part Ref 1, without aging: 70;
part made of alloy A1, with aging: 126;
reference part Ref 1 with aging: 80.

It is observed that:
the part made of alloy A1 has a significantly greater hardness than the reference part Ref 1, with or without aging, the mean increase in hardness being about 75% (without aging) and 60% (with aging).
aging enhances the hardness of the reference part Ref 1;
aging does not enhance the hardness of the part made of alloy A1 significantly. Without being bound by the theory, the inventors attribute this to the fact that there are not enough elements in solid solution, which induces little or no precipitation during aging.

The hot cracking properties were examined, so as to check the compatibility of the alloy A1 with use in an additive manufacturing process. The crack tendency index was established using the calculation of the head loss of the residual liquid which feeds the shrinkage that accompanies solidification. The greater the head loss over the solidification interval is, the easier the appearance of cracking during solidification, which corresponds to a high cracking susceptibility index. To calculate this index, a solidification path is simulated for each alloy, for example using the computing code CALPHAD, an acronym of Computer Coupling of Phase Diagrams and Thermochemistry. The crack tendency index quantifies the tendency of the alloy to crack during solidification. The crack tendency indices for the alloy A1 and for the reference alloy Ref 1 (2319) are 9 and 14, respectively.

This series of tests shows that using the alloy A1, it is possible to obtain, by additive manufacturing, a part in which the hardness and the cracking susceptibility are satisfactory, without any thermal treatment such as solution heat treatment and quenching. The part formed by additive manufacturing then does not undergo any deformation.

### Example 2

During a second series of tests, alloys including a higher Si and/or Sc content were used. The compositions as mass fraction percentages are given in Table 2 hereinafter.

TABLE 2

| Alloy | Si | Fe | Cu | Mn | Mg | Ti | V | Zr | Sc |
|---|---|---|---|---|---|---|---|---|---|
| A1 | 0.1% | 0.2% | 5.7% | 0.3% | 5% | 0.1% | 0.1% | 0.1% | |
| A2 | 0.1% | 0.2% | 5.7% | 0.3% | 5% | 0.1% | 0.1% | 0.1% | 0.2% |
| A3 | 3% | 0.2% | 5.7% | 0.3% | 5% | 0.1% | 0.1% | 0.1% | 0.3% |
| A4 | 3% | 0.2% | 5.7% | 0.3% | 6% | 0.1% | 0.1% | 0.1% | |
| Ref 2 | 0.1% | 0.2% | 5.7% | 0.3% | 0.5% | 0.1% | 0.1% | 0.1% | 0.2% |
| Ref 3 | 0.1% | 0.2% | 5.7% | 0.3% | | 0.1% | 0.1% | 0.1% | |
| Ref 4 | 5% | 0.2% | 5.7% | 0.3% | | 0.1% | 0.1% | 0.1% | |
| Ref 5 | 2.2% | 0.28% | | | 5.5% | | | | |
| Ref 6 | 3.5% | 0.28% | | | 7.5% | | | | |
| Ref 7 | 10% | | | | 0.4% | | | | |
| Ref 8 | 1.7% | 8.5% | | | | | 1.3% | | |

The reference alloys Ref 3 and Ref 8 correspond to 2319 and 8009 alloys, respectively. The alloy A1 corresponds to the alloy described in example 1.

Using each alloy, test parts such as those described in relation to example 1 were obtained. A post-manufacturing aging (175° C.—15 h) was applied on the parts formed from alloys not including scandium: A4, Ref 3 to Ref 7. A post-manufacturing annealing (325° C.—4 h) was applied on the parts formed from alloys including scandium. Annealing enables a precipitation of A1₃Sc dispersoids enhancing the hardness.

The hardness of each test part was measured:
in the unprocessed state, i.e., after manufacturing and before the thermal treatment;
after the post-manufacturing thermal treatment, whether it is aging or annealing.

The Vickers hardness can particularly be determined by following the method described in the standards EN ISO 6507-1 (Metallic materials—Vickers hardness test—Part 1: Test method), EN ISO 6507-2 (Metallic materials—Vickers hardness test—Part 2: Verification and calibration of testing machines), EN ISO 6507-3 (Metallic materials—Vickers hardness test—Part 3: Calibration of reference blocks) and EN ISO 6507-4 (Metallic materials—Vickers hardness test—Part 4: Tables of hardness values).

Table 3 shows the Hv 0.3 hardness values measured.

TABLE 3

| | | Hard- | Hard- | Hard- |
|---|---|---|---|---|
| | | ness In | ness | ness |
| | | unprocessed | after | after |
| Alloy | Composition | state | aging | annealing |
| A1 | Al—5.7Cu—5Mg | 126 | 128 | |
| A2 | Al—5.7Cu—5Mg—0.2Sc | 125 | | 138 |
| A3 | Al—5.7Cu—5Mg—3Si—0.3Sc | 161 | | 115 |
| A4 | Al—5.7Cu—6Mg—3Si | 164 | | |
| Ref 2 | Al—5.7Cu—0.5Mg—0.2Sc | 97 | | 103 |
| Ref 3 | 2319 - Al—5.7Cu | 70 | 80 | |
| Ref 4 | Al—5.7Cu—5Si | 101 | 105 | |
| Ref 5 | Al—5.5Mg—2.2Si | 90 | 104 | |
| Ref 6 | Al—5.5Mg—3.5Si | 90 | 96 | |
| Ref 7 | Al—10Si—0.4Mg | 84 | 100 | |
| Ref 8 | 8009 | 79 | | |

It is observed that:
on the parts obtained without thermal treatment, the maximum hardness values are obtained with the alloys A1 to A4, the values obtained being greater than 120 Hv.
The optimal results in terms of hardness are obtained with alloys A3 to A4, for which the Cu and Mg content is greater than 5%, and having a relatively high Si content (3%). The comparison of the alloys Ref 2 (0.5% Mg) and A2 (5% Mg) shows the effect of Mg. The composition A4 (5.7% Cu-6% Mg-3% Si) seems optimal in terms of hardness.
The presence of Si enhances the hardness in the unprocessed state, as shown by the comparison of the alloys A1 or A2 (without Si) and A3 and A4 (with Si);
The application of a thermal treatment such as annealing and aging can increase the hardness. However, when an alloy includes both Si and Sc, the application of a post-manufacturing thermal treatment does not seem to be recommended. See alloy A3.
The presence of scandium does not seem to have a significant effect on the hardness in the unprocessed state: see results relating to the alloys A4 (without Sc) and A3 (with Sc), indicating equivalent hardness values. On the other hand, in the absence of silicon and in the presence of scandium (see alloy A2), a post-manufacturing annealing step makes it possible to increase the hardness with respect to the unprocessed state.

A crack tendency index, as described in relation to example 1, was calculated for some alloys. The values obtained are shown in Table 4.

TABLE 4

| Alloy | Composition | Crack tendency index |
|---|---|---|
| A1 | Al—5.7Cu—5Mg | 9 |
| A2 | Al—5.7Cu—5Mg—0.2Sc | 9 |
| A4 | Al—5.7Cu—6Mg—3Si | 7 |
| Ref 1, Ref 3 | Al—5.7 Cu | 14 |
| (2319 alloy) | | |

It is observed that the alloys having optimal hardness values (A1, A2, A4) have a low crack tendency index. These alloys are therefore well-suited to an additive manufacturing process. The crack tendency index corresponding to the alloy A3 is considered to be similar to that of the alloy A4.

The tests presented above show that it is optimal to have an alloy:
wherein the Cu content is greater than or equal to 5%, being for example from 5% to 8%;
wherein the Mg content is greater than or equal to 4%, and preferably less than or equal to 8%. Preferably, the Mg content is greater than or equal to 4.5% or 5% and less than or equal to 8%.

The alloy can include silicon, the mass fraction being preferably greater than or equal to 1%, and preferably greater than or equal to 2%. The mass fraction of silicon is preferably less than or equal to 8%, or to 6%. The alloy can include zinc, according to a mass fraction less than or equal to 10%.

The alloy can include scandium, the mass fraction being less than or equal to 1%.

Additional Elements

The alloy can also include additional elements, for example selected from: W, Nb, Ta, Y, Yb, Er, Cr, Hf, Ce, La, Nd, Sm, Gd, Yb, Tb, Tm, Lu, Ni, Cr, Co, Mo and/or mischmetal, according to a mass fraction less than or equal to 2%, and preferably less than or equal to 1% for each element. Preferably, the total mass fraction of the additional elements is less than or equal to 5%, and preferably to 3% or to 2%. Such elements can cause the formation of dispersoids or fine intermetallic phases, which makes it possible to increase the hardness.

The alloy can include further additional elements selected from Sr, Ba, Sb, Bi, Ca, P, B, In, Sn, according to a mass fraction less than or equal to 1%, and preferably less than or equal to 0.1%, and more preferably less than or equal to 700 ppm for each element. Preferably, the total mass fraction of these elements is less than or equal to 2%, and preferably to 1%. It may be preferable to avoid an excessive addition of Bi, the preferred mass fraction then being less than 0.05%, and preferably less than 0.01%.

The alloy can include further additional elements such as:
Ag, according to a mass fraction of 0.06% to 1%;
and/or Li, according to a mass fraction of 0.06% to 2%.

These elements can act upon the resistance of the material by hardening precipitation or by the effect thereof on the properties of the solid solution.

According to an embodiment, the alloy can also comprise at least one element to refine the grains and prevent a coarse columnar microstructure, for example AlTiC or AlTiB₂, for example a refining agent in AT5B or AT3B form, according to a quantity less than or equal to 50 kg/ton, and preferably less than or equal to 20 kg/ton, even more preferably equal to 12 kg/ton for each element, and less than or equal to 50 kg/ton, and preferably less than or equal to 20 kg/ton for all of these elements.

Thermal Treatment

Following the formation of the layers, a thermal treatment can be applied. It can include a solution heat treatment followed by a quenching and an aging. However, as described above, the solution heat treatment induces a deformation of the part formed by additive manufacturing, particularly when the dimensions thereof are large. In addition, when a thermal treatment is applied, it is preferably for its temperature to be less than 500° C. or preferably less than 400° C., and for example between 100° C. and 400° C. It can in particular consist of an aging or an annealing. As a general rule, the thermal treatment can enable stress relieving of the residual stress and/or an additional precipitation of hardening phases.

According to an embodiment, the process can include hot isostatic compression (HIC). The HIC treatment can particularly make it possible to enhance the elongation properties and the fatigue properties. The hot isostatic compression can be carried out before, after or instead of the thermal treatment. Advantageously, the hot isostatic compression is carried out at a temperature of 250° C. to 550° C. and preferably of 300° C. to 450° C., at a pressure of 500 to 3000 bar and for a duration of 0.5 to 10 hours.

The optional thermal treatment and/or the hot isostatic compression can make it possible in particular to increase the hardness of the product obtained and/or reduce the porosity, which makes it possible to enhance the fatigue behavior and the ductility.

According to a further embodiment, adapted to structural hardening alloys, a solution heat treatment followed by a quenching and an aging of the part formed and/or a hot isostatic compression can be carried out. The hot isostatic compression can in this case advantageously replace the solution heat treatment.

However, the process according to the invention is advantageous, as it needs preferably no solution heat treatment followed by quenching. The solution heat treatment can have a harmful effect on the mechanical strength in certain cases by contributing to growth of dispersoids or fine intermetallic phases.

According to an embodiment, the method according to the present invention further optionally includes a machining treatment, and/or a chemical, electrochemical or mechanical surface treatment, and/or a tribofinishing. These treatments can be carried out particularly to reduce the roughness and/or enhance the corrosion resistance and/or enhance the resistance to fatigue crack initiation.

Optionally, it is possible to carry out a mechanical deformation of the part, for example after additive manufacturing and/or before the thermal treatment.

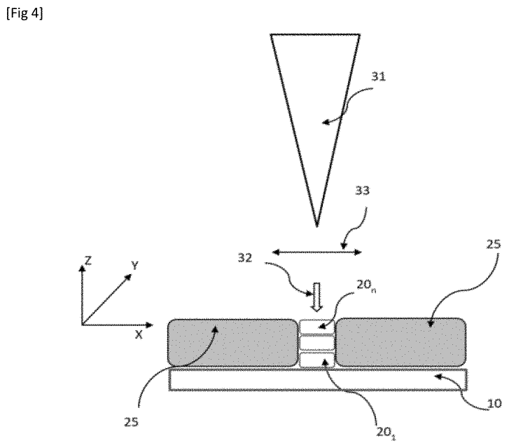

Though described in relation to a WAAM type additive manufacturing method, the process can be applied to other additive manufacturing methods. It can consist for example of a Selective Laser Melting (SLM) process. FIG. 4 schematically represents the operation of such a process. The filler metal 25 is presented in the form of a powder. An energy source, in this case a laser source 31, emits a laser beam 32. The laser source is coupled with the filler material by an optical system 33, the movement whereof is determined according to a digital model M. The laser beam 32 follows a movement along the longitudinal plane XY, describing a pattern dependent on the digital model. The interaction of the laser beam 32 with the powder 25 induces selective melting thereof, followed by a solidification, resulting in the formation of a layer 20₁ . . . 20ₙ. When a layer has been formed, it is coated with filler metal powder 25 and a further layer is formed, superimposed on the layer previously produced. The thickness of the powder forming a layer can for example be between 10 and 150 μm.

The powder can have at least one of the following features:
mean particle size of 5 to 100 μm, preferably from 5 to 25 μm, or from 20 to 60 μm. The values given signify that at least 80% of the particles have a mean size within the specified range;
spherical shape. The sphericity of a powder can for example be determined using a morphogranulometer;
good castability. The castability of a powder can for example be determined as per the standard ASTM B213 or the standard ISO 4490:2018. According to the standard ISO 4490:2018, the flow time is preferably less than 50 s;
low porosity, preferably of 0 to 5%, more preferably of 0 to 2%, even more preferably of 0 to 1% by volume. The porosity can particularly be determined by scanning electron microscopy or by helium pycnometry (see the standard ASTM B923);
absence or small quantity (less than 10%, preferably less than 5% by volume) of small, so-called satellite, particles (1 to 20% of the mean size of the powder), which adhere to the larger particles.

Further processes can also be envisaged, for example, and non-restrictively:
Selective Laser Sintering or SLS;
Direct Metal Laser Sintering or DMLS;
Selective Heat Sintering or SHS;
Electron Beam Melting or EBM;
Laser Melting Deposition;
Direct Energy Deposition or DED;
Direct Metal Deposition or DMD;
Direct Laser Deposition or DLD;
Laser Deposition Technology;
Laser Engineering Net Shaping;
Laser Cladding Technology;
Laser Freeform Manufacturing Technology or LFMT;
Laser Metal Deposition or LMD;
Cold Spray Consolidation or CSC;
Additive Friction Stir or AFS;
Field Assisted Sintering Technology, FAST or spark plasma sintering; or
Inertia Rotary Friction Welding or IRFW.

1. A process for manufacturing a part comprising formation of successive metal layers, which are superimposed on each other, each layer being formed by depositing a filler metal, the filler metal being subjected to a supply of energy so as to become molten and upon solidifying, constituting said layer wherein the filler metal is an aluminum alloy comprising the following alloy elements (% by weight);
Cu: 5%-8%;
Mg: 4%-8%;
optionally Si: 0%-8%;
optionally Zn: 0%-10%;
as well as:
other elements: <3% individually, the other elements including: Sc and/or Fe and/or Mn and/or Ti and/or Zr and/or V and/or Cr and/or Ni;
impurities: <0.05% individually, and in total <0.15%;
the remainder being aluminum.

2. The process according to claim 1, wherein Mg: 4.5% to 8%.

3. The process according to claim 1, wherein the aluminum alloy includes the following other elements:
Fe: 0.05%-2%;
and/or Mn: 0.05%-0.4%;
and/or Ti: 0.05%-0.4%
and/or Zr: 0.05%-0.5%;
and/or V: 0.08%-0.5%;
and/or Sc: 0.05%-0.5%;
and/or Cr: 0.05%-0.5%;
and/or Ni: 0.05%-0.5%.

4. The process according to claim 1, wherein the mass fraction of the other elements, taken as a whole, is less than 10%, and optionally less than 5%.

5. The process according to claim 1, wherein the aluminum alloy includes Si: 0.05%-1%, optionally 0.2%-1%.

6. The process according to claim 1, wherein the aluminum alloy includes Si >1%.

7. The process according to claim 1, wherein the aluminum alloy includes at least one of: Sc: 0.05%-1% and/or Zr: 0.05%-2%, optionally Sc: 0.05%-1% and Zr: 0.05%-2%.

8. The process according to claim 1, including, following the formation of the layers, an application of at least one thermal treatment.

9. The process according to claim 8, wherein the thermal treatment is an aging or an annealing.

10. The process according to claim 1, not including a quenching type thermal treatment following the formation of the layers.

11. The process according to claim 1, wherein the filler metal is obtained from a filler wire, the exposure of which to an electric arc results in a localized melting followed by a solidification, so as to form a solid layer.

12. The process according to claim 1, wherein the filler metal takes the form of a powder, the exposure of which to a light beam or charged particles results in a localized melting followed by a solidification, so as to form a solid layer.

13. A part obtained by a process according to claim 1.

14. A filler wire, intended to be used as a filler material of an additive manufacturing process, wherein said filler wire is formed from an aluminum alloy, including the following alloy elements (% by weight):
Cu: 5%-8%;
Mg: 4%-8%;
at least one among: Sc: 0.05%-1% and/or Zr: 0.05%-2%, optionally Sc: 0.05%-1% and Zr: 0.05%-2%;
optionally Si: 0%-8%;
optionally Zn: 0%-10%;
as well as
other elements: <2% individually, the other elements including: Fe and/or Mn and/or Ti and/or V and/or Cr and/or Ni;
impurities: <0.05% individually, and in total <0.15%;
the remainder being aluminum.
